(19) United States
(12) Patent Application Publication
(10) Pub. No.: US 2026/0057566 A1
(43) Pub. Date: Feb. 26, 2026

(54) DATA PROCESSING SYSTEM CAPABLE OF SIMULTANEOUSLY DISPLAYING IMAGES AND SETTING PICTURE QUALITY PARAMETERS AND METHOD THEREOF

(71) Applicant: BENQ CORPORATION, Taipei City (TW)

(72) Inventor: Yu-Ching TUNG, Taipei City (TW)

(73) Assignee: BENQ CORPORATION, Taipei City (TW)

(21) Appl. No.: 19/176,374

(22) Filed: Apr. 11, 2025

(30) Foreign Application Priority Data
Aug. 22, 2024 (TW) 113131580

(51) Int. Cl. G06T 11/00; G06T 7/10

(52) U.S. Cl. CPC G06T 11/00; G06T 7/10

(57) ABSTRACT

A data processing system, includes a display device and a local computing device. An image generating unit of the display device performs an image processing operation to generate an image of a multimedia theme, and the image has multiple parameters. An image capturing unit of the local computing device captures the image. A computing unit performs an operation based on the captured image, so as to obtain a text index of the multimedia theme. A second communication unit transmits the text index to the remote device, and receives a set of parameter setting values corresponding to the text index, from the remote device. The display device parses a first command to obtain the parameter setting values, and performs a setting operation according to the parameter setting values to set the parameters of the image.

This application claims the benefit of Taiwan application Serial No. 113131580, filed August 22, 2024, the disclosure of which is incorporated by reference herein in its entirety.

### TECHNICAL FIELD

The present disclosure relates to a data processing mechanism, and particularly relates to a data processing system for processing picture quality parameters and a method thereof.

### BACKGROUND

Projectors can be used to magnify multimedia themes and project them onto a wall or a projection screen, thereby enhancing the user's visual experience. The picture quality of the image produced by the projector is usually adjusted, so as to suit the contents or scenes of different types of multimedia themes (including computer games or audio/video programs), so as to provide users with better visual experiences.

In the operation mode for existing projectors, in order to adapt to specific contents or scenes of the multimedia theme, the user is usually required to manually set the parameters of the projector image (such as brightness parameters, contrast parameters, or color saturation parameters) to adjust the picture quality of the projector. However, manual parameter setting often consumes a lot of time, resulting in an interruption or delayed-display of multimedia themes, which may seriously deteriorate the user's visual experiences and increase the user's operation time.

In view of the above issues, it is necessary to provide an improved data processing mechanism that can efficiently set the parameters of the projector image, and the parameter setting can be executed synchronously with the image displaying.

### SUMMARY

According to one embodiment of the present disclosure, a data processing system is provided. The data processing system includes a display device and a local computing device. The display device includes the following elements. An image generating unit, for performing an image processing operation to generate an image of a multimedia theme, the image having a plurality of parameters. A first communication unit, for receiving a first command, the display device performs a setting operation according to the first command. The local computing device includes the following elements. An image capturing unit, for capturing the image. A computing unit, for performing an operation according to the captured image, so as to obtain a text index of the multimedia theme. A second communication unit, for transmitting the text index to a remote device, and receiving a set of parameter setting values corresponding to the text index from the remote device. A third communication unit, for transmitting the first command to the display device. The display device parses the first command to obtain the set of parameter setting values, and executes the setting operation according to the set of parameter setting values to set the parameters of the image.

According to another embodiment of the present disclosure, a data processing method is provided. The data processing method is applied to a display device which includes an image generating unit for performing an image processing operation to generate an image of a multimedia theme, the image having a plurality of parameters. The data processing method includes the following steps. Capturing the image by an image capturing unit of a local computing device. Performing an operation by a computing unit of the local computing device according to the captured image, so as to obtain a text index of the multimedia theme. Transmitting the text index to a remote device by a second communication unit of the local computing device, and receiving a set of parameter setting values corresponding to the text index from the remote device. Transmitting a first command to the display device by a third communication unit of the local computing device. Receiving the first command by a first communication unit of the display device. Parsing the first command by the display device to obtain the set of parameter settings. Executing a setting operation according to the set of parameter setting values by the display device to set the parameters of the image.

### BRIEF DESCRIPTION OF THE DRAWINGS

FIG. 1 is a functional block diagram of a data processing system according to an embodiment of the present disclosure.

FIG. 2 is a functional block diagram of a display device according to an embodiment of the present disclosure.

FIG. 3 is a functional block diagram of a local computing device according to an embodiment of the present disclosure.

FIG. 4 is a functional block diagram of a remote device according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

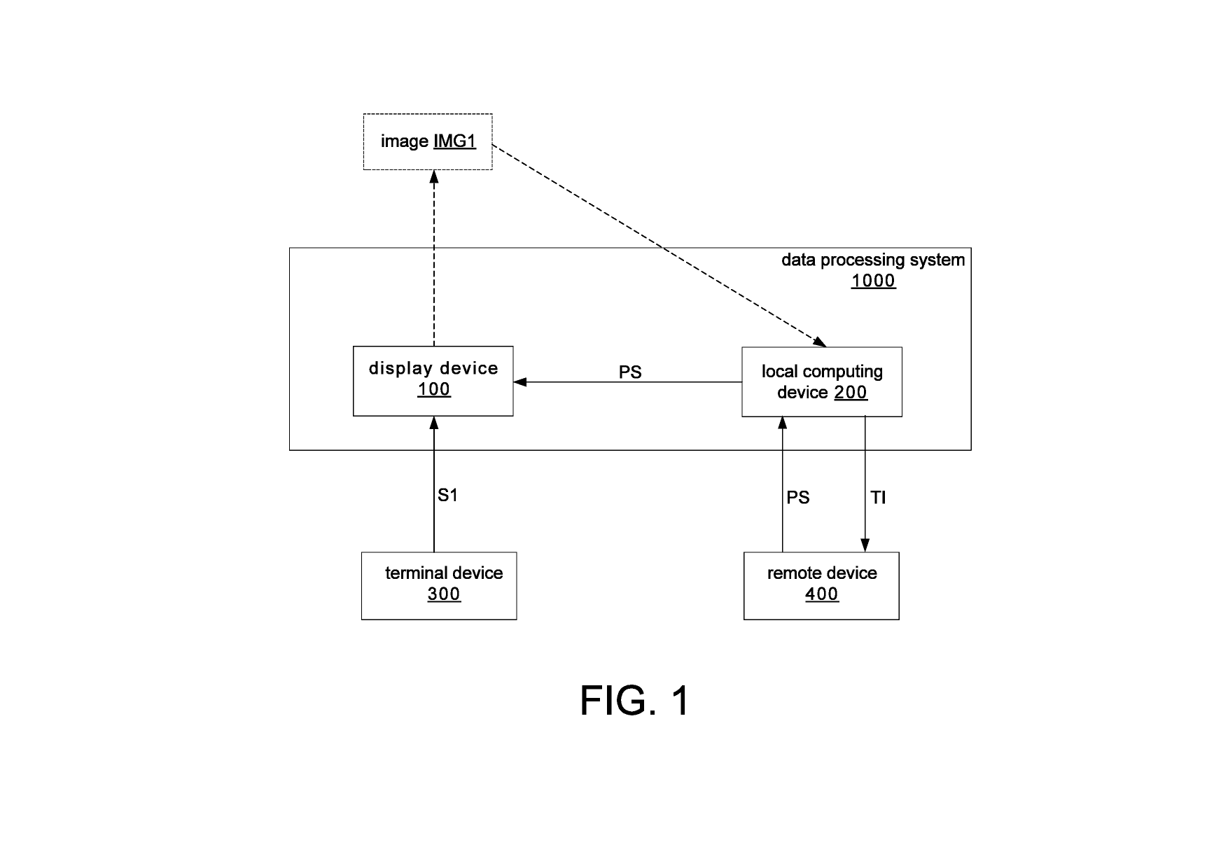

FIG. 1 is a functional block diagram of a data processing system 1000 according to an embodiment of the present disclosure. As shown in FIG. 1, the data processing system 1000 includes a display device 100 and a local computing device 200. The data processing system 1000 cooperates with a terminal device 300 and a remote device 400.

The terminal device 300 is, for example, a game console, a television, a personal computer, a mobile phone, or an audio/video player. An user operates the terminal device 300 to execute a multimedia theme; the multimedia theme is, for example, a computer game, an audio/video program, or a video conference. The terminal device 300 transmits a signal S1 of the multimedia theme to the display device 100.

The display device 100 is, for example, a projector. The display device 100 performs an image processing operation according to the signal S1 of the multimedia theme provided by the terminal device 300, so as to generate an image IMG1 of the multimedia theme. Furthermore, the display device 100 projects the image IMG1 of the multimedia theme onto a wall or a projection screen. The image IMG1 of the multimedia theme is, for example, a static image formed by a single picture/photo, or a dynamic image formed by a plurality of continuous and related pictures/photos.

The image IMG1 of the multimedia theme has a plurality of picture quality modes (PQ modes), which correspond to a plurality of picture quality parameters, including: a brightness parameter, a contrast parameter, and a color saturation parameter. In response to multimedia themes of different types or different contents, these picture quality parameters of the image IMG1 of the multimedia theme may be adjusted to different parameter values. For example, when the multimedia theme is an audio/video program that broadcasts outdoor sports events of the Olympics, the brightness parameter of the image IMG1 of the multimedia theme can be adjusted to high brightness to reflect the brightness of the outdoor environment. For another example, when the multimedia theme is a computer game, such as “Mario Kart”, which is a game with cute cartoon characters, the color saturation parameter of the image IMG1 of the multimedia theme can be adjusted to a high saturation to reflect the color style of the cartoon characters.

The local computing device 200 is an edge computing device that has an image capturing function to capture images, and has a model computing capability to perform edge computing. The local computing device 200 is, for example, a smart phone, a tablet computer, a wearable device, or a personal computer (including a desktop computer and a notebook computer). The local computing device 200 captures the image IMG1 of the multimedia theme projected by the display device 100 onto the wall or the projection screen, and the local computing device 200 performs edge computing according to the captured image IMG1 to obtain a text index TI associated with the multimedia theme. The text index TI may include: theme name, role name, object name, theme type, and scene type of the multimedia theme. For example, when the multimedia theme is an audio/video program of "Baseball games in the Olympics", the theme name of the multimedia theme is "Baseball Game", and the role names are "Pitcher", "Catcher", "Batter", etc. Furthermore, the object names are "bat", "base plate", and "home run wall", the theme type is "outdoor ball game", and the scene type is "outdoor stadium".

Then, the local computing device 200 transmits the text index TI of the multimedia theme to the remote device 400. The remote device 400 is, for example, a cloud computing device. Compared to the local computing device 200 which is disposed at a local side and performs edge computing, the remote device 400 is disposed at a remote side and performs central computing. The remote device 400 has a built-in mapping table, which includes a mapping relationship between a text index TI of a multimedia theme and a parameter setting values PS of a picture quality parameter. After receiving the text index TI of the multimedia theme, the remote device 400 obtains a set of parameter setting values PS corresponding to the text index TI according to the mapping relationship in the mapping table. The parameter setting values PS is used to set the picture quality parameter of the image IMG1 of the multimedia theme generated by the display device 100.

Then, the local computing device 200 receives the parameter setting values PS corresponding to the text index TI of the multimedia theme from the remote device 400. Furthermore, the local computing device 200 transmits the parameter setting values PS to the display device 100. Then, the display device 100 performs a setting operation according to the parameter setting values PS to set the picture quality parameter of the image IMG1 of the multimedia theme. During the operation of the display device 100, the setting operation for setting the picture quality parameters and the image processing operation for generating the image IMG1 of the multimedia theme can be executed synchronously; therefore, when the display device 100 needs to set or adjust the picture quality parameters of the image IMG1 of the multimedia theme, the display device 100 can still synchronously generate the image IMG1 of the multimedia theme, and continuously project the image IMG1 of the multimedia theme onto a wall or a projection screen. The image IMG1 of the multimedia theme can be smoothly presented to the user, and the user can obtain a good visual experience without delay or interruption of the image IMG1 of the multimedia theme which may be caused by the setting operation of the picture quality parameters.

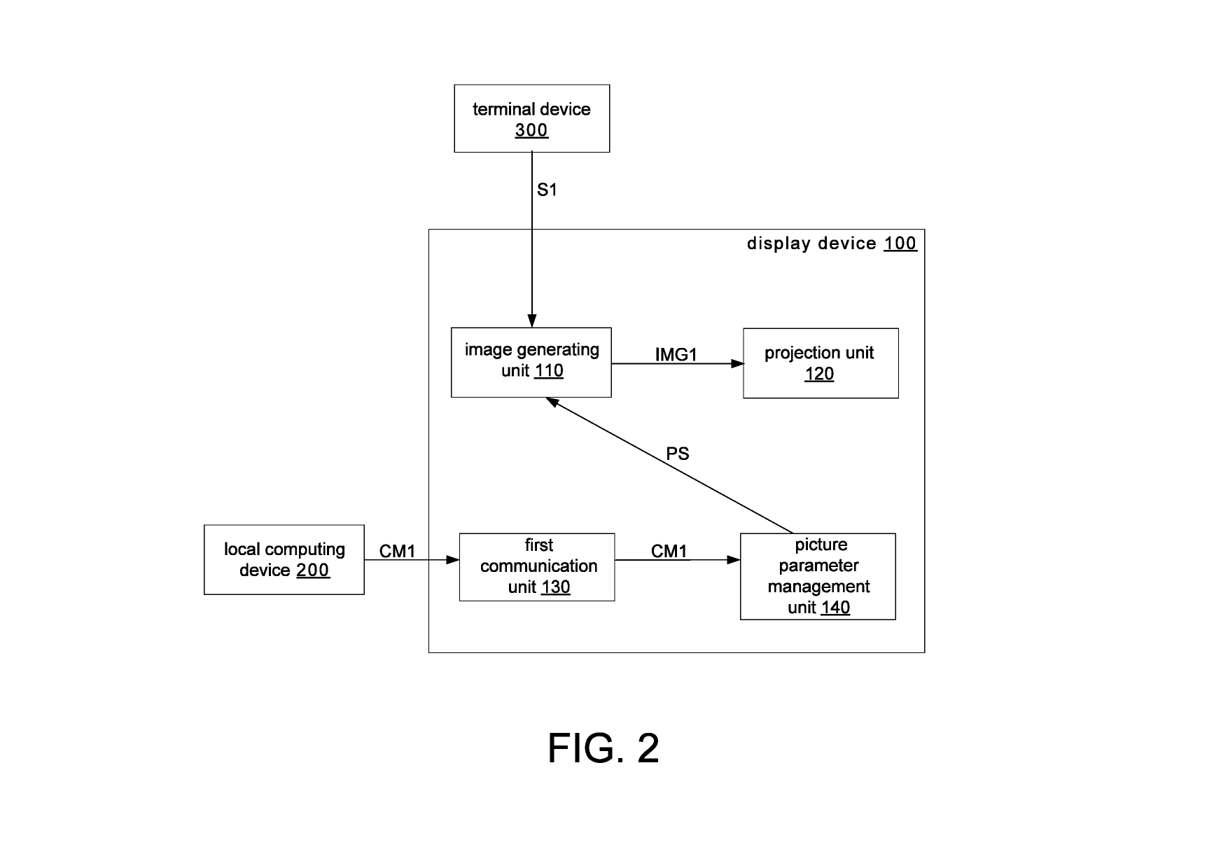

FIG. 2 is a functional block diagram of a display device 100 according to an embodiment of the present disclosure. As shown in FIG. 2, the display device 100 includes an image generating unit 110, a projection unit 120, a first communication unit 130 and a picture parameter management unit 140. The image generating unit 110 receives the signal S1 of the multimedia theme from the terminal device 300, and the image generating unit 110 performs an image processing operation according to the signal S1 of the multimedia theme to generate the image IMG1 of the multimedia theme. Then, the image generating unit 110 transmits the electrical signal of the image IMG1 of the multimedia theme to the projecting unit 120. The projection unit 120 converts the electrical signal of the image IMG1 of the multimedia theme into an optical signal, and projects the optical signal of the image IMG1 of the multimedia theme onto a wall or a projection screen.

The first communication unit 130 is communicatively coupled to the local computing device 200. The display device 100 performs wired and/or wireless network communication according to the first network communication protocol by the first communication unit 130, so as to transmit and/or receive data and control commands with the local computing device 200. For example, the first communication unit 130 receives a first command CM1 from the local computing device 200, and the content of the first command CM1 includes a parameter setting values PS of the picture quality parameter of a multimedia theme.

The picture parameter management unit 140 parse the first command CM1 to obtain the parameter setting values PS of the multimedia theme, and the picture parameter management unit 140 performs a setting operation to set the image IMG1 of the multimedia theme based on the parameter setting values PS.

Synchronous to the setting operation performed by the picture parameter management unit 140, the image generation unit 110 generates the image IMG1 of the multimedia theme which is set, according to the parameter setting values PS. The projection unit 120 projects the image IMG1 of the multimedia theme which is set, onto a wall or a projection screen.

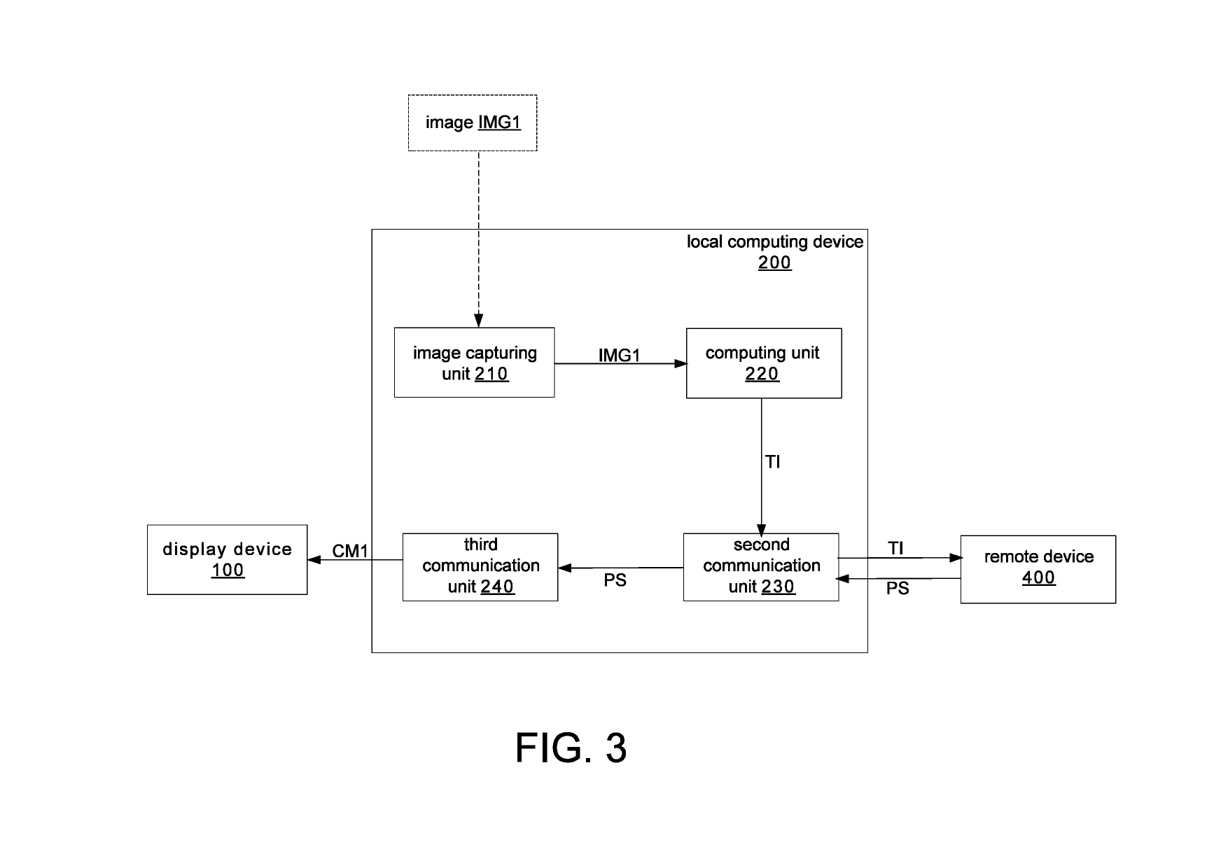

FIG. 3 is a functional block diagram of a local computing device 200 according to an embodiment of the present disclosure. As shown in FIG. 3, the local computing device 200 includes an image capturing unit 210, a computing unit 220, a second communication unit 230, and a third communication unit 240. The image capturing unit 210 is, for example, a camera, and is used to capture the image IMG1 of the multimedia theme projected onto a wall or a projection screen by the projection unit 120 of the display device 100. The computing unit 220 is, for example, a processor, including a microcontroller unit (MCU), a central processing unit (CPU), or a graphics processing unit (GPU).

The computing unit 220 performs operations according to the image captured by the image capturing unit 210 to obtain a text index TI of the multimedia theme. In one example, the computing unit 220 performs an image segmentation model (SAM) operation to recognize the role name and/or object name of the multimedia theme based on the image captured by the image capturing unit 210, and the theme name of the multimedia theme can be obtained based on the operation of the SAM operation. In another example, the computing unit 220 performs a residual network (ResNet) operation, which recognizes the role name, object name and/or theme name of the multimedia theme according to the image captured by the image capturing unit 210.

The second communication unit 230 is communicatively coupled to the remote device 400. The local computing device 200 executes wired and/or wireless network communication according to the second network communication protocol by the second communication unit 230, so as to transmit the text index TI of the multimedia theme, which is calculated by the calculation unit 220, to the remote device 400. Furthermore, the local computing device 200 receives the parameter setting values PS corresponding to the text index TI from the remote device 400, by the second communication unit 230.

The third communication unit 240 receives the parameter setting values PS from the second communication unit 230. Furthermore, the third communication unit 240 is communicatively coupled to the first communication unit 130 of the display device 100. The local computing device 200 executes wired and/or wireless network communication according to the first network communication protocol by the third communication unit 240, so as to transmit and/or receive data and control commands with the display device 100. For example, the third communication unit 240 transmits a first command CM1 (the content of the first command CM1 includes a parameter setting values PS of the picture quality parameter of a multimedia theme) to the display device 100.

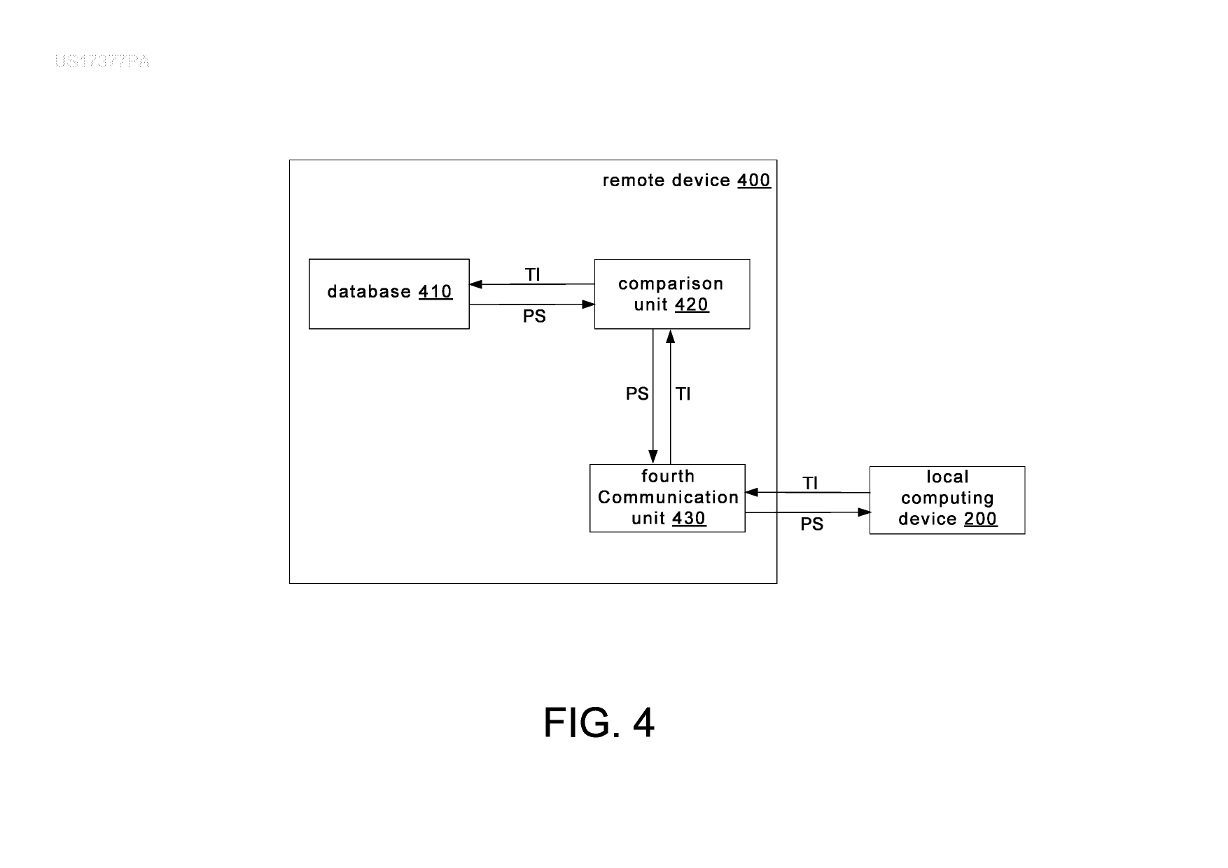

FIG. 4 is a functional block diagram of a remote device 400 according to an embodiment of the present disclosure. As shown in FIG. 4, the remote device 400 includes a database 410, a comparison unit 420 and a fourth communication unit 430. The database 410 stores a mapping table; the mapping table includes a mapping relationship between the text index TI of the multimedia theme and the parameter setting values PS. Furthermore, the database 410 can also store a theme name list; the theme name list includes a plurality of predefined theme names. When the theme name of the multimedia theme falls within the range of the theme name list, it indicates that the multimedia theme can be parsed and processed by the remote device 400.

The fourth communication unit 430 is communicatively coupled to the local computing device 200. The remote device 400 performs wired and/or wireless network communication according to the second network communication protocol by the fourth communication unit 430, so as to receive the text index TI of the multimedia theme from the second communication unit 230 of the local computing device 200.

The comparison unit 420 receives the text index TI from the fourth communication unit 430, and the comparison unit 420 analyzes the text index TI, so as to compare the theme names in the text index TI with the predefined theme names included in the theme name list. When the comparison unit 420 confirms that the theme name in the text index TI matches one of the above-mentioned predefined theme names, it means that the theme name in the text index TI is included in the theme name list, confirming that this multimedia theme can be parsed and processed by the remote device 400; then, the remote device 400 further generates the parameter setting values PS corresponding to the text index TI of the multimedia theme according to the mapping table stored in the database 410. Then, the fourth communication unit 430 transmits the parameter setting values PS to the local computing device 200.

Following the above descriptions in the former paragraphs, the following paragraphs provide two embodiments to describe how the display device 100 sets the picture quality parameters in the picture quality mode. In the first embodiment, the terminal device 300 is, for example, a television, and the user operates the terminal device 300 at the local side to execute the multimedia theme, such as an audio/video program of "Baseball games in the Olympics". The terminal device 300 transmits the signal of the audio/video program of "Baseball games in the Olympics" to the display device 100, which is, for example, a projector. The display device 100 performs image processing operations according to the signal of the audio/video program "Baseball games in the Olympics" to generate images (such as dynamic images) of this audio/video program, and the display device 100 projects the images of this audio/video program onto the wall or the projection screen. Furthermore, the user operates the local computing device 200 at the local side to capture the image projected by the display device 100 on the wall or the projection screen. The local computing device 200 is, for example, a smart phone. The camera of the smart phone can capture the image of this audio/video program projected by the display device 100, and the processor of the smart phone can perform edge computing to obtain the text index TI associated with this audio/video program. The text index TI includes, for example, the theme name "Olympic Baseball Championship", the role name "Batter", the object name "Bat", the theme type "Outdoor ball games" and the scene type "Outdoor stadium" of the this audio/video program. Then, the local computing device 200 transmits the text index TI to the remote device 400.

The remote device 400 is a cloud computing device operating at the remote side, such as a cloud server. The mapping table stored in the remote device 400 includes a mapping relationship between the text index TI and the parameter setting values PS of the picture quality parameters. The remote device 400 performs central computing at the remote side, and analyzes the mapping relationship between text indexes TI of the "Olympic Baseball Championship", "Batter", "Bat", "Outdoor ball games" and "Outdoor stadium" according to the mapping table, so as to obtain a set of parameter setting value PS for the picture quality parameters of the audio/video program “Baseball games in the Olympics". The picture quality parameters include, for example, brightness parameters, contrast parameters, and color saturation parameters. According to the mapping relationship of the mapping table of the remote device 400, text indexes TI of the "Olympic Baseball Championship", "Batter", "Bat", "Outdoor ball games" and "Outdoor stadium" are mapped to picture quality parameters of high brightness, high contrast and high color saturation. The remote device 400 obtains corresponding parameter setting value PS, for example: a first brightness value (brightness=80), a first contrast value (contrast=70) and a first color saturation value (saturation=65).

Then, the local computing device 200 receives the parameter setting value PS of the first brightness value (brightness=80), the first contrast value (contrast=70) and the first color saturation value (saturation=65), etc. from the remote device 400. Furthermore, the local computing device 200 transmits the parameter setting values PS to the display device 100. Synchronous to the image processing operation of generating the audio/video program "Baseball games in the Olympics", the display device 100 simultaneously performs a setting operation, so as to set the picture quality parameters of this audio/video program to the first brightness value (brightness=80), the first contrast value (contrast=70) and the first color saturation value (saturation=65). Since the setting operation is performed synchronously with the image processing operation, this audio/video program will not be delayed or interrupted caused by the setting operation which will reduce the user's visual experience.

In the second embodiment, the terminal device 300 is, for example, a game console, and the user operates the terminal device 300 locally to execute a multimedia theme of the game "Mario Kart". The terminal device 300 transmits the signal of the game "Mario Kart" to the display device 100 (e.g., a projector) to perform image processing operations, so as to generate an image of the game "Mario Kart" and project it onto the wall or the projection screen. The user operates the camera of the local computing device 200 to capture the image projected on the wall or the projection screen, and the processor of the local computing device 200 performs edge computing to obtain the text index TI associated with the game "Mario Kart". The text index TI includes, for example, a theme name "Mario Kart", a role name "Mario Bros.", an object name "racing car", a theme type "competitive game" and a scene type "racing track". Then, the local computing device 200 transmits the text index TI to the remote device 400.

The remote device 400 performs central computing at the remote side, and analyzes the mapping relationship between the text indexes TI such as "Mario Kart", "Mario Bros.", "racing car", "competitive game" and "racing track" according to the mapping table, so as to obtain a set of parameter setting values PS for the picture quality parameters of the game "Mario Kart". The corresponding picture quality parameters are medium brightness, medium contrast and high color saturation, and the corresponding parameter setting values PS are, for example, a second brightness value (brightness=50), a second contrast value (contrast=50) and a second color saturation value (saturation=60).

Then, the local computing device 200 receives the parameter setting values PS from the remote device 400, and transmits the parameter setting values PS to the display device 100. Synchronous to the image processing operation of the display device 100 for generating the image of the audio/video program "Baseball games in the Olympics", the display device 100 synchronously performs the image processing operation and the setting operation, so as to generate the image of the game "Mario Kart" and synchronously set the picture quality parameters of the game "Mario Kart" to the second brightness value (brightness=50), the second contrast value (contrast=50) and the second color saturation value (saturation=60).

In summary, the data processing system 1000 of the present disclosure performs edge computing by the local computing device 200 to obtain the text index TI (including the theme name, role name, object name, theme type, scene type, etc.) of the multimedia theme which is projected by the display device 100. Furthermore, the data processing system 1000 cooperates with the remote device 400 to perform central computing, so as to obtain the parameter setting values PS of the mapped picture quality parameters according to the text index TI generated by the local operation device 200.

The display device 100 sets the image IMG1 of the multimedia theme according to the parameter setting values PS obtained by the remote device 400. Synchronous to the setting operation performed on the image IMG1 of the multimedia theme by the display device 100, the display device 100 can simultaneously perform the image processing operation to generate the image IMG1 of the multimedia theme, and project the image IMG1 onto the wall or the projection screen. Therefore, the image IMG1 of the multimedia theme will not be delayed or interrupted, and the user can have a good visual experience when viewing the image IMG1 of the multimedia theme.

It will be apparent to those skilled in the art that various modifications and variations can be made to the disclosed embodiments. It is intended that the specification and examples be considered as exemplars only, with a true scope of the disclosure being indicated by the following claims and their equivalents.

WHAT IS CLAIMED IS:

1. A data processing system, comprising:
a display device, comprising:
an image generating unit, for performing an image processing operation to generate an image of a multimedia theme, the image having a plurality of parameters; and
a first communication unit, for receiving a first command, the display device performs a setting operation according to the first command;
and
a local computing device, comprising:
an image capturing unit, for capturing the image;
a computing unit, for performing an operation according to the captured image, so as to obtain a text index of the multimedia theme;
a second communication unit, for transmitting the text index to a remote device, and receiving a set of parameter setting values corresponding to the text index from the remote device; and
a third communication unit, for transmitting the first command to the display device,
wherein the display device parses the first command to obtain the set of parameter setting values, and executes the setting operation according to the set of parameter setting values to set the parameters of the image.

2. The data processing system of claim 1, wherein the display device executes the setting operation and the image processing operation synchronously.

3. The data processing system of claim 1, wherein the display device is a projector, the multimedia theme is a computer game, a video program, or a video conference; and the local computing device is an edge computing device which comprises a smart phone, a tablet computer, a wearable device, a desktop computer, and a notebook computer.

4. The data processing system of claim 1, wherein the image is a static image or a dynamic image, and the parameters of the image comprise at least a brightness parameter, a contrast parameter, and a color saturation parameter.

5. The data processing system of claim 1, wherein the first communication unit of the display device and the third communication unit of the local computing device perform wired/wireless network communication according to a first network communication protocol.

6. The data processing system of claim 1, wherein the text index of the multimedia theme comprises a theme name, and/or a role name, and/or an object name, and/or a theme type, and/or a scene type.

7. The data processing system of claim 6, wherein the operation performed by the computing unit of the local computing device is an image segmentation model (SAM) operation, which is used to recognize the role name and/or the object name based on the captured image and used to obtain the theme name.

8. The data processing system of claim 6, wherein the operation performed by the computing unit of the local computing device is a residual network (ResNet) operation, which is used to recognize the theme type and/or the scene type based on the captured image and used to obtain the theme name.

9. The data processing system of claim 1, wherein the remote device is a cloud computing device, and the remote device comprising:
a database, for storing a theme name list and a mapping table, wherein the mapping table comprises a mapping relationship between the text index and the set of parameter setting values.

10. The data processing system of claim 9, wherein when the remote device confirms that the theme name is comprised in the theme name list, the remote device obtains the set of parameter setting values corresponding to the text index according to the mapping table; and the remote device and the second communication unit of the local computing device perform wired/wireless network communication according to a second network communication protocol.

11. A data processing method, which is applied to a display device, the display device comprises an image generating unit for performing an image processing operation to generate an image of a multimedia theme, the image having a plurality of parameters, and the data processing method comprising:
capturing the image by an image capturing unit of a local computing device;
performing an operation by a computing unit of the local computing device according to the captured image, so as to obtain a text index of the multimedia theme;
transmitting the text index to a remote device by a second communication unit of the local computing device, and receiving a set of parameter setting values corresponding to the text index from the remote device;
transmitting a first command to the display device by a third communication unit of the local computing device;
receiving the first command by a first communication unit of the display device;
parsing the first command by the display device to obtain the set of parameter settings; and
executing a setting operation according to the set of parameter setting values by the display device to set the parameters of the image.

12. The data processing method of claim 11, wherein the display device executes the setting operation and the image processing operation synchronously.

13. The data processing method of claim 11, wherein the display device is a projector, the multimedia theme is a computer game, a video program, or a video conference; and the local computing device is an edge computing device which comprises a smart phone, a tablet computer, a wearable device, a desktop computer, and a notebook computer.

14. The data processing method of claim 11, wherein the image is a static image or a dynamic image, and the parameters of the image comprise at least a brightness parameter, a contrast parameter, and a color saturation parameter.

15. The data processing method of claim 11, wherein the first communication unit of the display device and the third communication unit of the local computing device perform wired/wireless network communication according to a first network communication protocol.

16. The data processing method of claim 11, wherein the text index of the multimedia theme comprises a theme name, and/or a role name, and/or an object name, and/or a theme type, and/or a scene type.

17. The data processing method of claim 16, wherein the operation performed by the computing unit of the local computing device is an image segmentation model (SAM) operation, which is used to recognize the role name and/or the object name based on the captured image and used to obtain the theme name.

18. The data processing method of claim 16, wherein the operation performed by the computing unit of the local computing device is a residual network (ResNet) operation, which is used to recognize the theme type and/or the scene type based on the captured image and used to obtain the theme name.

19. The data processing method of claim 11, wherein the remote device is a cloud computing device, and the data processing method further comprises:
storing a theme name list and a mapping table by a database of the remote device;
wherein the mapping table comprises a mapping relationship between the text index and the set of parameter setting values.

20. The data processing method of claim 19, further comprising:
confirming, by the remote device, whether the theme name is comprised in the theme name list; and
when the theme name is comprised in the theme name list, obtaining the set of parameter setting values corresponding to the text index according to the mapping table, by the remote device,
wherein the second communication unit of the local computing device and the remote device perform wired/wireless network communication according to a second network communication protocol.
